(19) United States
(12) Patent Application Publication
(10) Pub. No.: US 2007/0063365 A1
(43) Pub. Date: Mar. 22, 2007

(54) Carbon Dioxide Cylinder Formation

(76) Inventors: Frederick W. Giacobbe, Naperville, IL (US); Elizabeth A. Giacobbe, Naperville, IL (US)

Correspondence Address: Ms. Linda K. Russell, Air Liquide Intellectual Property Dept., 2700 Post Oak Blvd., Suite 1800, Houston, TX, 77056, US

(21) Appl. No.: 11/466,029

(22) Filed: Aug. 21, 2006

Related U.S. Application Data
(60) Provisional application No. 60/716,234, filed on Sep. 12, 2005.

(51) Int. Cl. B05B 3/00

(52) U.S. Cl. 264/28; 249/78; 249/117; 249/79

(57) ABSTRACT

Method and system for forming solid cylinders of carbon dioxide. In one embodiment, liquid carbon dioxide is expanded into at least one molding tube to produce dry ice snow. The dry ice snow is compressed into solid cylinders of carbon dioxide by the pressure of the liquid carbon dioxide entering the molding tube.

### CROSS-REFERENCE TO RELATED APPLICATIONS

This application claims the benefit under 35 U.S.C. § 119(e) to provisional application No. 60/716,234, filed Sep. 12, 2005, the entire contents of which are incorporated herein by reference.

### BACKGROUND

Solid carbon dioxide (dry ice) is traditionally manufactured by first producing carbon dioxide liquid. This is done by compressing carbon dioxide gas and removing any excess heat. The carbon dioxide is typically liquefied at pressures ranging from 200-300 pounds per square inch and at a temperature of −20° F. to 0° F., respectively. Liquid carbon dioxide is typically stored in a pressure vessel at lower than ambient temperature. The liquid pressure is then reduced below the triple point pressure of about 75 PSI by sending it through an expansion valve. This can be done in a single step or, in many cases, by reducing the liquid pressure to 100 PSI at a temperature of −50° F. as a first step to allow easy recovery of flash gases. The liquid carbon dioxide is expanded inside a dry ice manufacturing press to form a mixture of dry ice solid and cold gas. The cold gas is vented or recycled and the remaining dry ice snow is then compacted to form blocks. Dry ice is typically compacted to a density of approximately 90 lb/ft³. A common method of compacting dry ice snow is using in-line hydraulic cylinders or high powered rotary compression devices, followed by hydraulic extrusion of cylindrical pellets. Both the in-line hydraulic cylinders and the high powered rotary compression devices are expensive to make and may require extensive maintenance during normal operation.

There therefore exists a need for alternative approaches to forming solid carbon dioxide.

### SUMMARY

The embodiments of the present invention generally provide a method and system for forming solid carbon dioxide cylinders. One embodiment of the invention provides a method for forming a solid carbon dioxide cylinders by providing a liquid carbon dioxide source and providing at least one mold, e.g., a molding tube. The at least one molding tube may have a first end (e.g., top end) and a second end (e.g., bottom end) and a retaining member (alternatively referred to herein as a “closure”) for retaining solid carbon dioxide positioned at the bottom end of the at least one molding tube. Carbon dioxide gas may flow through the closure, which may be removeably attached to the bottom end of the at least one molding tube. Liquid carbon dioxide is flowed from the liquid carbon dioxide source to the top end of the at least one molding tube, and allowed to expand from the top end of the at least one molding tube and into the at least one molding tube. The expanding results in the formation of solid carbon dioxide snow which is compressed by the pressure of the liquid carbon dioxide entering the at least one molding tube. The compressed solid carbon dioxide cylinder may be removed from the at least one molding tube after opening or removing the closure at the bottom end of the molding tube. In one embodiment, heat may be applied to the at least one molding tube in order to facilitate the removal of the solid carbon dioxide cylinder from the molding tube.

Another embodiment of the invention provides a system for forming a solid carbon dioxide cylinder having at least one molding tube with a top end and a bottom end, and a closure positioned at the bottom end of the at least one molding tube. The closure retains solid carbon dioxide and allows carbon dioxide gas to flow through, and may be removeably attached to the at least one molding tube. A liquid carbon dioxide source is in fluid communication with the at least one molding tube. In embodiment, a hearting source to provide heat to the at least one molding tube is also provided. The heating source may in one embodiment be a warm gas supply and, in another embodiment, a warm fluid supply. In one embodiment, least one molding tube has an inner diameter of between about 0.25 inches and about 6 inches. In another embodiment the diameter is between about 1 inch and about 3 inches. In one embodiment, the at least one molding tube has a length of between about 3 inches and about 36 inches, and in another embodiment the length is between about 15 inches and about 20 inches.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a flow chart of a process for forming solid carbon dioxide cylinders, according to one embodiment of the invention;

FIG. 2 is a schematic diagram of a processing unit for forming solid carbon dioxide cylinders, according to one embodiment of the invention;

FIG. 3 is a schematic diagram of a processing unit for forming solid carbon dioxide cylinders, according to one embodiment of the invention; and

FIG. 4 is a schematic diagram of a processing unit for forming solid carbon dioxide cylinders, according to one embodiment of the invention.

### DESCRIPTION OF PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

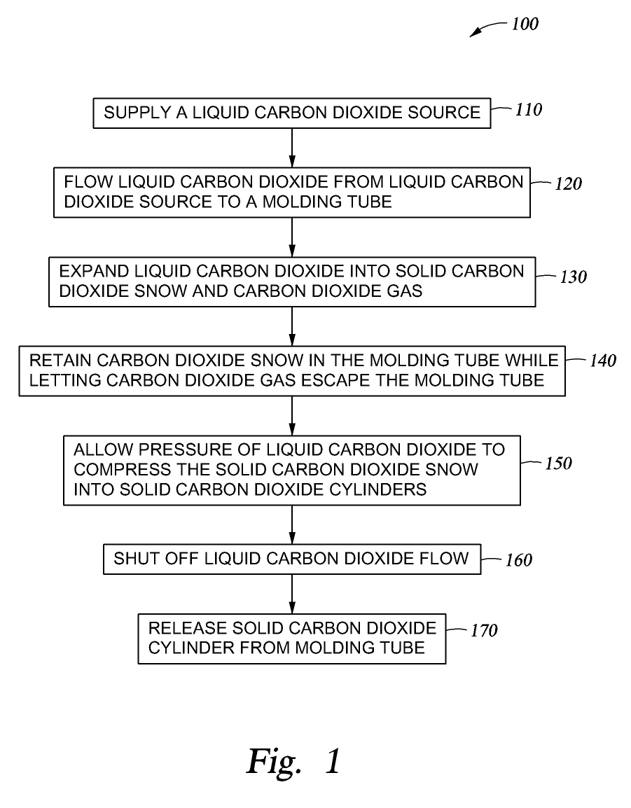

FIG. 1 illustrates a flow chart of a process 100 for forming solid carbon dioxide cylinders, according to one embodiment of the invention. In step 110, a liquid carbon dioxide source is provided. Liquid carbon dioxide is flowed from the liquid carbon dioxide source and to a molding tube (step 120), where it is expanded and converted into solid carbon dioxide snow and carbon dioxide gas (step 130). The carbon dioxide snow is retained in the molding tube while the carbon dioxide gas is allowed to escape the molding tube (step 140). In step 150, the pressure from the flow of liquid carbon dioxide compresses the solid carbon dioxide snow into a solid carbon dioxide cylinder. The liquid carbon dioxide flow may be shut off (step 160) and a solid carbon dioxide cylinder may be released from the molding tube (step 170).

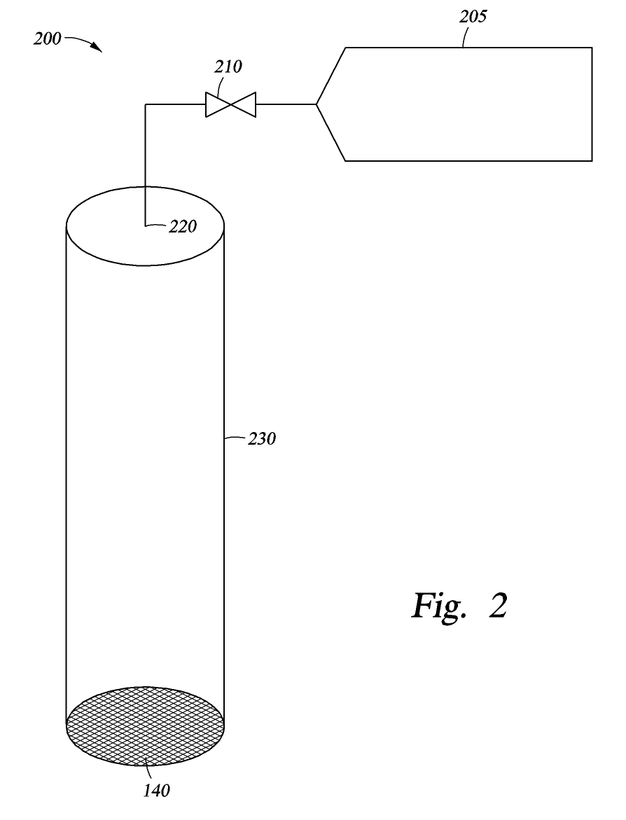

FIG. 2 illustrates a schematic diagram of a processing unit 200 for the formation of solid carbon dioxide cylinders, according to one embodiment of the invention. Liquid carbon dioxide source 205 provides liquid carbon dioxide to a molding tube 230. As used herein, liquid carbon dioxide source 205 may consist of one or more tanks or other sources of liquid carbon dioxide. Control of the flow of liquid carbon dioxide gas from liquid carbon dioxide source 205 is provided via valve 210, which may be a manual or automatic valve as is known in the art. Liquid carbon dioxide flows into a top end of molding tube 230 via outlet nozzle 220. In one embodiment, outlet nozzle 220 may have an inner diameter between about ⅛ inch and about 2 inches, and in a particular embodiment may be between about ¼ inch and about 1 inch. In one embodiment, molding tube 230 may have an inner diameter between about ¼ inch and about 10 inches, and in a particular embodiment may be between about ¼ inch and about 6 inches, and a length between about 3 inches and about 48 inches, and in a particular embodiment may be between about 3 inches and about 36 inches. In one embodiment the length may be 18 inches and the inner diameter may be 2 inches. The molding tube 230 may be positioned in a vertical manner; alternatively the molding tube 230 may be positioned in a tilted angle.

A gas permeable closure 240 may be positioned at the bottom end of molding tube 230. Gas permeable closure 240 allows carbon dioxide gas to escape molding tube 230, while retaining solid carbon dioxide snow formed in molding tube 230. Gas permeable closure 240 may be made of any gas permeable material, such as flexible cloth or filter paper, glass or ceramic, or metal or polymer meshed screens. Gas permeable closure 240 may be removeably attached to the bottom end of the molding tube 230. Mechanisms for attaching gas permeable closure 240 to the bottom end of the molding tube 230 may include using screws, bolts, screw caps, or any other attaching device, including pneumatic, mechanical and electrical attaching devices. Alternatively gas permeable closure 240 may be permanently attached to the bottom end of the molding tube 230. In one embodiment, at least one surface, or section of at least one surface, of molding tube 230 is gas permeable, allowing for the carbon dioxide gas to escape the molding tube from the at least one surface of molding tube 230.

In one embodiment of the invention, valve 210 is opened, and liquid carbon dioxide may flow from liquid carbon dioxide source 205 and into molding tube 230. The liquid carbon dioxide in liquid carbon dioxide source 205 may have a temperature between about −70° F. (the triple point temperature) and about 88° F. (the critical temperature), preferably, between about 0° F. and about 80° F. The liquid carbon dioxide may be maintained at a pressure between about 75 PSI (the triple point pressure) and about 1072 PSI (the critical pressure), preferably, between about 100 PSI and about 900 PSI. In one embodiment the liquid carbon dioxide may be maintained at a pressure of about 800 PSI at ambient temperature (about 68° F.). In another embodiment the liquid carbon dioxide may be maintained at a pressure of about 300 PSI at about 0° F. The liquid carbon dioxide exits outlet nozzle 220 and is expanded the molding tube 230 to form a mixture of dry ice snow and cold gas. The cold gas is vented through the gas permeable membrane 240, and may be recycled into liquid carbon dioxide gas again. However, gas permeable membrane 240 retains the dry ice snow, and the molding tube 230 continues to be filled with solid dry ice snow. The pressure of the liquid carbon dioxide entering the molding tube 230, results in the dry ice snow being compressed into a dense solid carbon cylinder within the molding tube 230. After molding tube 230 has been filled up by the solid carbon cylinder, the valve 210 is closed, shutting off the flow of liquid carbon dioxide. The gas permeable membrane 240 may then be removed from the bottom of molding tube 230, and the solid carbon dioxide cylinder removed from the molding tube 230. The solid carbon dioxide cylinder may be removed from the molding tube 230 by gravity, or it may be extruded from the molding tube 230. If the gas permeable membrane 240 is permanently attached to molding tube 230, molding tube 230 may be turned over, in order to let the solid carbon dioxide cylinder drop out of molding tube 230. In one embodiment heat may be applied to the outer surface of molding tube 230 in order to facilitate removing the solid carbon dioxide cylinder from molding tube 230. Heat may be provided in the form of hot air or by a warm circulating fluid.

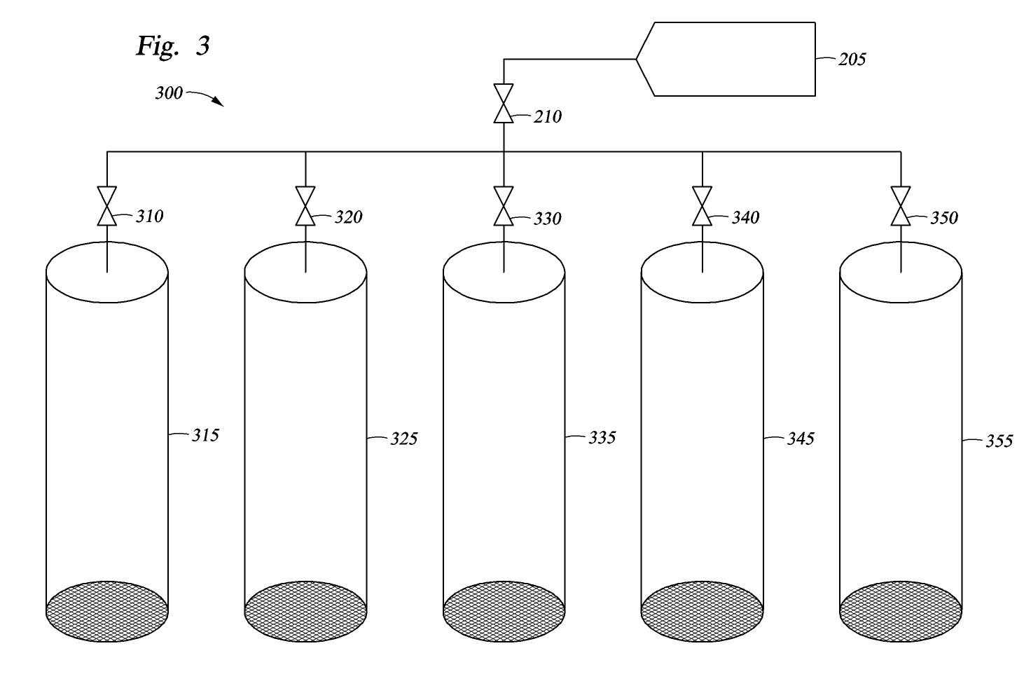

FIG. 3 illustrates a schematic diagram of a processing unit 300 for the formation of solid carbon dioxide cylinders, according to one embodiment of the invention. In this embodiment, several molding tubes 315, 325, 335, 345, and 355 are provided. In addition to carbon dioxide source 205 and valve 210, molding tubes 315, 325, 335, 345, and 355 receive liquid carbon dioxide controlled by individual valves 310, 320, 330, 340, and 350, respectively. Thus, the valves may be controlled so that each molding tube may be at various stages of solid carbon dioxide cylinder production, and a cyclic continuous production may be obtained. Alternatively, all or groups of molding tubes may be filled simultaneously for bulk production. Although six molding tubes are shown in FIG. 3, any number of molding tubes may be contemplated.

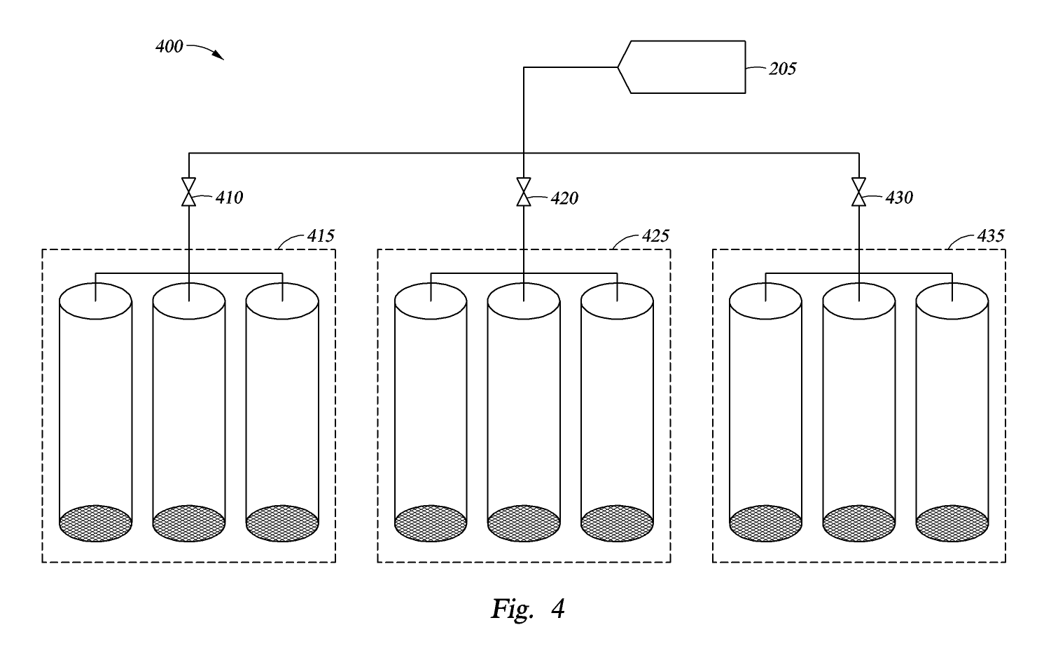

FIG. 4 illustrates a schematic diagram of a processing unit 400 for the formation of solid carbon dioxide cylinders, according to one embodiment of the invention. In this embodiment, several molding tubes are connected in several sets of molding tubes. Molding tube sets 415, 425, and 435, receive liquid carbon dioxide via valves 410, 420, and 430, respectively. Liquid carbon dioxide may first be set to flow to molding tube set 415, after a predetermined amount of time, or after the molding tubes of set 415 have received a predetermined amount of liquid carbon dioxide, liquid carbon dioxide may also be delivered to molding tube set 420. Upon completion of filling molding tube set 410 with solid carbon dioxide, valve 410 may be shut off, and valve 430 opened to allow liquid carbon dioxide to flow into molding tube set 435. Solid carbon dioxide cylinders are then removed from molding tube set 415, and valve 410 opened as valve 420 is closed, allowing for the removal of solid carbon dioxide cylinders from molding tube set 425. The opening and closing of valves 410, 420, and 430, and removing of solid carbon dioxide cylinders from the molding tube sets, may continue in a continuous cyclic manner.

The processes described in FIGS. 1-4, may be performed manually. Alternatively an automated system is assembled where the valves are opened and closed based on instructions from a centralized command central. The command central may also control the opening and closing of the gas permeable membranes. Thus a fully automated solid carbon dioxide cylinder formation process is possible

### EXAMPLES

### Example 1

In this example a molding tube having a length of 18 inches and a diameter of 2 inches was used to produce a solid carbon dioxide cylinder. Liquid carbon dioxide was provided from a source storing the liquid carbon dioxide at a temperature of about 0° F. and a pressure of about 300 PSI. Liquid carbon dioxide was flowed until a solid carbon dioxide cylinder formed in the molding tube. A dense solid carbon dioxide cylinder having a diameter of about 2 inches and a length of about 18 inches resulted.

### Example 2

In this example a molding tube having a length of 18 inches and a diameter of 2 inches was used to produce a solid carbon dioxide cylinder. Liquid carbon dioxide was provided from a source storing the liquid carbon dioxide at about ambient temperatures (about 68° F.) and a pressure of about 800 PSI. Liquid carbon dioxide was flowed until a solid carbon dioxide cylinder formed in the molding tube. A dense solid carbon dioxide cylinder having a diameter of about 2 inches and a length of about 18 inches resulted.

Although embodiments have been described with reference to forming cylindrical solid carbon dioxide objects, it is contemplated that the solid carbon dioxide may be formed in any desired shape, e.g., shapes having a polygonal cross-section such rectangles, squares, etc.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for producing solid carbon dioxide objects, comprising:
a) providing a liquid carbon dioxide source;
b) providing at least one mold having a first end and a second end wherein a retaining member for retaining solid carbon dioxide is positioned at the second end of the at least one mold;
c) flowing liquid carbon dioxide from the liquid carbon dioxide source to the first end of the at least one mold; the liquid carbon dioxide being allowed to expand into the at least one mold, wherein expanding the liquid carbon dioxide results in the formation of solid carbon dioxide snow; and
e) allowing a pressure of the liquid carbon dioxide to compress the solid carbon dioxide snow into at least one solid carbon dioxide object.

2. The method of claim 1, further comprising allowing carbon dioxide gas to flow through the retaining member.

3. The method of claim 2, wherein the retaining member is removeably attached to the second end of the at least one mold.

4. The method of claim 3, further comprising removing the retaining member from the second end of the mold.

5. The method of claim 4, further comprising:
f) providing heat to the at least one mold; and
g) removing the at least one solid carbon dioxide object from the at least one mold.

6. The method of claim 1, further comprising removing the at least one solid carbon dioxide object from the at least one mold.

7. The method of claim 1, wherein the at least one mold comprises a plurality of sets of molds.

8. The method of claim 6, wherein the sets of molds are alternately filled with compressed carbon dioxide snow.

9. The method of claim 1, wherein the at least one mold has an inner diameter of between about 0.25 inches and about 6 inches.

10. The method of claim 1, wherein the at least one mold has a length of between about 3 inches and about 36 inches.

11. The method of claim 1, wherein the pressure has a value between about 100 PSI and about 900 PSI.

12. The method of claim 11, wherein the liquid carbon dioxide has a temperature between about 0° F. and about 80° F.

13. The method of claim 12, wherein the pressure is about 300 PSI and the temperature is about 0° F.

14. The method of claim 12, wherein the pressure is about 800 PSI and the temperature is about 68° F.

15. A method for producing solid objects of carbon dioxide, comprising:
a) providing at least one mold having a first end and a second end wherein a retaining member for retaining solid carbon dioxide is positioned at the second end of the at least one mold, and wherein at least one surface of the mold is gas permeable;
b) flowing liquid carbon dioxide from a liquid carbon dioxide source to a first end of a mold; the liquid carbon dioxide being allowed to expand into the mold, wherein expanding the liquid carbon dioxide results in the formation of solid carbon dioxide snow, and wherein one or more gases are allowed to permeate the at least one surface during expansion of the liquid carbon dioxide; and
c) allowing a pressure of the liquid carbon dioxide to compress the solid carbon dioxide snow into at least one solid carbon dioxide object.

16. The method of claim 15, further comprising:
d) providing heat to the at least one mold; and
e) removing the at least one solid carbon dioxide object from the at least one mold.

17. The method of claim 15, wherein the at least one mold comprises a plurality of sets of molds.

18. The method of claim 17, wherein the sets of molds are alternately filled with compressed carbon dioxide snow.

19. The method of claim 15, wherein the pressure has a value between about 100 PSI and about 900 PSI.

20. The method of claim 19, wherein the liquid carbon dioxide has a temperature between about 0° F. and about 80° F.

21. The method of claim 20, wherein the pressure is about 300 PSI and the temperature is about 0° F.

22. The method of claim 20, wherein the pressure is about 800 PSI and the temperature is about 68° F.

23. A system for producing solid objects of carbon dioxide, comprising:
a) at least one mold comprising:
i) a first end; and
ii) a second end;
b) a retaining member positioned at the second end of the at least one mold, wherein the retaining member retains solid carbon dioxide and allows carbon dioxide gas to flow through; and
c) a liquid carbon dioxide source in fluid communication with the at least one mold.

24. The system of claim 23, further comprising an outlet for delivering liquid carbon dioxide into the at least one mold.

25. The system of claim 23, further comprising a heating source to provide heat to the at least one mold.

26. The system of claim 23, wherein the retaining member is removeably attached to the second end of the at least one mold.

27. The system of claim 23, wherein the at least one mold comprises a plurality of sets of molds.

28. The system of claim 23, wherein the at least one mold has an inner diameter of between about 0.25 inches and about 6 inches.

29. The system of claim 28, wherein the inner diameter is between about 1 inch and about 3 inches.

30. The system of claim 23, wherein the at least one mold has a length of between about 3 inches and about 36 inches.

31. The system of claim 30, wherein the length is between about 15 inches and about 20 inches.

32. The system of claim 25, wherein the heating source is a warm gas supply.

33. The system of claim 25, wherein the heating source is a warm fluid supply.
